(19) United States
(12) Patent Application Publication
(10) Pub. No.: US 2010/0089889 A1
(43) Pub. Date: Apr. 15, 2010

(54) Method And Apparatus For Controlling A Welding System

(75) Inventor: Richard M. Hutchison, Iola, WI (US)

Correspondence Address: CORRIGAN LAW OFFICE, 5 BRIARCLIFF CT, APPLETON, WI, 54915, US

(73) Assignee: Illinois Tool Works Inc., Glenview, IL (US)

(21) Appl. No.: 12/250,076

(22) Filed: Oct. 13, 2008

(51) Int. Cl. B23K 9/00

(52) U.S. Cl. 219/137 PS; 219/136

(57) ABSTRACT

A method and apparatus for welding includes one or more of a welding type power source, a feedback circuit, a wire feeder and a controller. The controller preferably has an eta control circuit responsive to the feedback.

### FIELD OF THE INVENTION

The present invention relates generally to the art of welding and welding power supplies. More specifically, it relates to the control of the welding process and welding power supplies.

### BACKGROUND OF THE INVENTION

There are many known welding power supplies used for a variety of welding processes, such as short circuit MIG, spray transfer and pulsed spray transfer. Welding power supply or system for welding, as used herein, includes one or more of the following components: a wire feeder, a power source or source of power, a torch or gun, a controller, including a wire feeder controller, and a power source controller to control the various components (it may also exclude some of these components). The components may share a housing, or be in separate housings.

Power source, or source of power, as used herein, includes the power circuitry such as rectifiers, switches, transformers, SCRs, etc that process and provide the output power. Controller, as used herein, includes digital and analog circuitry, discrete or integrated circuitry, microprocessors, DSPs, etc., software, hardware and firmware, located on one or more boards, and used to control a welding process, or a device such as a power source or wire feeder.

The components of a welding power supply cooperate to produce a welding output. Generally, the controller controls the other components such that the output parameters (welding current and/or voltage, wire feed speed, etc.) are at a desired level, either set by the user or set by the power supply for the type of process being used.

There are numerous control schemes currently being used. Typically, a control scheme includes receiving feedback, and controlling a command signal in response to that feedback. Feedback, as used herein, includes a signal indicative of or responsive to an output or intermediate signal, which is provided to the controller and control decisions are made in response thereto. Responsive to a parameter, as used herein, includes responding to changes in a value of the parameter or a function of that parameter, such as changing the value of a control signal or other parameter, opening or closing a switch, etc.

Prior art controllers use any number of well known control schemes, such as PID control, comparing a feedback signal to a threshold, open loop control, etc. An example of a prior art control scheme is the control scheme in the MM250®. That control is particularly well suited for MIG welding.

The MM250® controller receives two user-selectable inputs, one indicating desired welding voltage, and the other desired wire feed speed. User-selectable, as used herein, includes the user setting an operating parameter set point. The controller also receives feedback of these parameters, and compares the set points to the fedback back values. The difference between the set point and the fedback value, or difference error, is integrated over time, and used to change commands such that the output tends to the set point.

One welding process is a short-arc process (and is performed particularly well by the MM250® power supply). The process has an arc phase, in which the wire advances to the puddle faster than it is melted by the arc. Eventually it reaches the puddle, and the process enters the short phase. Current flow increases in this phase, until it causes a molten metal bridge between the weld puddle and the wire to be broken. This causes the short to be opened, and the process returns to the arc phase. The process alternates between the short and arc phases many times each second.

Typical GMAW systems, including short circuit MIG, spray and pulsed spray transfer, utilize feedback of the electrical parameters of the weld (voltage and/or current) to maintain the process in a desirable operating range.

Short circuit MIG typically uses an average voltage set point for controlling the process. A voltage control is used to maintain the arc voltage at the selected value. This may be an open loop system in a constant voltage tapped transformer machine or a voltage control loop with arc voltage feedback. Control loop, open or closed, as used herein, includes a portion of a controller that controls in response to the value of a particular variable.

Closed loop voltage control can be affected as the connection between the welding power supply and the welding arc changes. Changes in weld cable length or other factors can effect the overall impedance of the welding circuit change the feedback voltage and modify the welding process. Prior art systems have used voltage sense leads to address these problems. However, voltage sense leads require additional wiring that is susceptible to damage in the typically harsh welding environment, and can be influenced by electrical noise that can interfere with the control scheme.

Spray transfer is controlled in generally the same manner as short circuit MIG transfer. However, the voltage setpoint for spray transfer is adjusted to a level such there are few or no short circuit events. Control of spray transfer suffers from the same difficulties faced by control of a short circuit MIG process.

Pulsed spray transfer involves a more sophisticated current waveform which enables the process to substantially transfer the molten wire across the arc during the relatively high peak current phase of the waveform while maintaining an overall lower heat input than the spray transfer at the same deposition setting. Prior art pulse welding systems often rely upon some form of voltage feedback to control the arc length so that it is essentially constant. Arc length may be maintained using average voltage over a time period. The Miller Accupulse® process uses instantaneous feedback during the peak and/or background times. As with short circuit MIG, dependence upon voltage feedback results in control of pulse spray MIG welding suffering from the issues raised above.

The prior art has suggested that the variable eta may be useful in controlling the welding process. Eta, as used herein, is Tsht/(Tsht+Tarc), where Tsht is the length of time of a short circuit and Tarc is the length of time of the successive arc. Some prior art literature suggests that the MIG welding process will be more stable when eta has a value between 0.2 and 0.3. However, prior art control schemes, particularly those used for CV output, do not generally monitor eta, much less control in response to it.

Accordingly, a welding power supply that controls the welding power in response to temporal parameters, such as eta, is desirable, particularly for short circuit MIG, spray transfer, and pulse spray transfer.

### SUMMARY OF THE PRESENT INVENTION

According to a first aspect of the invention a system for welding includes a welding-type power source, a feedback circuit and a controller. The power source has at least one control input and a welding-type output. The feedback circuit is responsive to the state of the weld and has a feedback output. The controller has a feedback input connected to the feedback output, and a temporal control circuit that is responsive to the feedback input, and a control output connected to the control input.

According to a second aspect of the invention a method of welding includes providing welding-type power to a weld and monitoring the state of the weld, The welding-type power is temporally controlled in response to the monitoring.

According to a third aspect of the invention a system for welding includes a welding-type power source that has at least one control input and a welding-type output. A feedback circuit is responsive to state of the weld and has a feedback output. A controller has a feedback input connected to the feedback output, and has temporal control circuit that is responsive to the feedback input, and has a control output that is responsive to the length of at least one arc state, and the control output is connected to the control input.

According to a fourth aspect of the invention a method of providing welding power includes providing welding-type power to a weld and monitoring the state of the weld. The welding-type power is temporally controlled in response to the monitoring and the duration of at least one arc state.

The temporal control circuit is an eta control circuit in an alternative embodiment, and/or has an eta window and an eta calculation circuit in other embodiments. The eta control circuit is not responsive to the eta setpoint when the eta calculation circuit determines eta is inside the eta window in an alternative embodiment.

The eta setpoint is a user selectable eta setpoint in an alternative embodiment.

The controller has a user selectable wire feed speed setpoint and/or a voltage set point, and a wire feed speed and/or voltage control circuit in alternative embodiments.

The eta control circuit includes an output indicative of the number of short circuit and/or arc states in a given time period in alternative embodiments.

The control circuit includes an averaging circuit and/or the temporal control circuit includes a short time control circuit responsively connected to the control output in alternative embodiments.

Other principal features and advantages of the invention will become apparent to those skilled in the art upon review of the following drawings, the detailed description and the appended claims.

### BRIEF DESCRIPTION OF THE DRAWINGS

FIG. 1 includes a controller constructed in accordance with the preferred embodiment of one aspect of the invention; and

FIG. 2 is a diagram of a welding system in accordance with one aspect of the invention.

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to a particular welding power supply, used in a particular process, and implemented with particular components, it should be understood at the outset that the invention can also be implemented with other welding power supplies, other processes, and implemented with other components, software, hardware etc.

Generally, the various aspects of this invention will be described using a MIG welding power supply, such as the Miller MM250® or a Miller XMT® welding power supply. This preferred embodiment includes a power source, a wire feeder, and a controller, that may be housed in a single housing, or in multiple housings. The controller may be on a single board, distributed on multiple boards, and a single housing, or distributed in multiple housings. The controllers preferably are comprised of analog and digital circuitry, although they may be implemented exclusively with either.

One aspect of the invention relates to the response time of the controller. The control scheme determines the value of eta. If eta is within a desirable window, then the control scheme provides for a relatively slow response time because the process should be stable with such an eta. However, if eta is outside the desirable window, then the control scheme provides for a faster response time because the process may be, or may be becoming, unstable, and a rapid output change is needed to bring the process back to a stable output. Window, as used herein, refers to a range of values that includes the desired set point and predetermined values both above and below the set point, not necessarily symmetrically disposed about the set point.

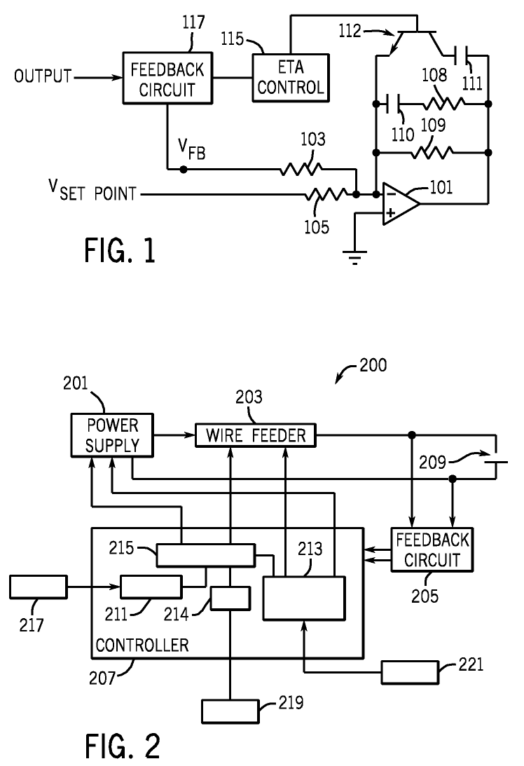

Referring now to FIG. 1, the preferred embodiment implementing this aspect of the invention is shown. A voltage/eta controller includes a voltage it receives on an input to a voltage feedback input through a resistor 103 and a voltage set point signal through a resistor 105. These signals are of opposite polarity, so that the difference between them is applied to the input of the error amplifier 101. The feedback circuit of error amplifier 101 includes a feedback resistor 109, another feedback resistor 108, and capacitors 110 and 111.

A switch 112 is provided in electrical communication with, and preferably in series with, capacitor 111. Electrical communication with, as used herein, includes a connection wherein electrical signals and/or power may be provided or received. In series with, as used herein, includes connected such all current flowing in a first component flows in a second component, either directly or through intermediate components.

The controller for switch 112 opens and closes switch 112 based on the value of eta, by providing the appropriate gate signal or switch control input. Switch, as used herein, includes one or more switches (digital, analog, software or mechanical) commonly controlled. Switch control input, is an input to a switch that at least partially determines the state (on or off, e.g.) of the switch.

When switch 112 is closed, and capacitor 111 is in the feedback loop, the error amplifier has a slower response time, and thus the entire control has a slow response time. Conversely, when the capacitor is switched out of the feedback loop, the error amplifier has a faster response time, and thus the entire control has a faster response time. Switch 112 is open when eta has a value outside of the desired window of between 0.2 and 0.3.

Thus, it may be seen that the control has a slower response time when the process is stable (as indicated by eta being within the window of the 0.2 and 0.3), and, generally, the controller is a CV controller. The operation of the error circuit, other than the variable response time, is much like a typical error CV circuit. It includes an error amplifier receiving a voltage feedback signal and a voltage set point of opposite polarity. The difference between these two signals is amplified, integrated, and a command signal in response thereto, is provided as a control output, and received as a control input by the power source to adjust the output.

Control output, as used herein, includes an output used to control a power supply, such as a set point, gate signals, phase control signals, etc. Control input, as used herein, includes an input used to control a power supply, such as a set point, gate signals, phase control signals, etc.

The controller shown has two control loops: a voltage control loop having voltage feedback, and a nested, temporal control loop having eta as the control variable. Voltage control loop, as used herein, includes a control loop that controls in response to the value of a voltage variable. Temporal control loop or circuit, as used herein, includes a control loop or circuit that provides a control output responsive to the time the weld is in the short state and/or the arc state. Responsive to, as used herein, includes controlling in response to a parameter or a signal responsive to a parameter, either directly or indirectly.

The temporal loop may be considered having a response time selector, because it adjusts the response time of the voltage loop. Response time selector, as used herein, includes a circuit that controls the response time of a control loop. The voltage loop has a selectable response time. Selectable, as used herein, includes being able to change a value or parameter to one of a plurality of values, or to a value in one or more continuum of values.

The controller also includes an eta control circuit 115, to control the power in response to an eta parameter. Control circuit 115, which determines if eta is within the window, such as by using two comparators, and provides an eta output that turns on and off switch 112. Control circuit, as used herein, includes digital and analog circuitry, discrete or integrated circuitry, microprocessors, DSPs, etc., software, hardware and firmware, located on one or more boards, that form part or all of a controller, and are used to control a welding process, or a device such as a power source or wire feeder. Controlling the welding-type power in response to a parameter, as used herein, includes controlling in response to a value indicative of or derived from the parameter.

A feedback circuit 117 monitors the output voltage and provides a feedback output to a feedback input of the controller. The eta control circuit uses the voltage feedback to determine if the arc state is a short or an arc. Feedback circuit, as used herein, includes a circuit that provides a signal indicative of or responsive to an output or intermediate signal. Feedback input, as used herein, includes an input to a control circuit that receives a signal indicative of or responsive to a measured parameter. Feedback output, as used herein, includes an output of a feedback circuit that is indicative of or responsive to a measured parameter.

Alternative embodiments include providing a different window, or providing a response time that, rather than being selected from one of two values, is within a range of response times. This may be accomplished by varying the relative amount of time switch 112 is closed, such as by pulse width modulation, or varying time on and time off etc. This provides a variable capacitance and a variable response time of any value within a range of values, or many discrete values.

Other embodiments provide for varying the response time using a microprocessor controller or a digital controller, rather than the analog controller of FIG. 1. Analog controller, as used herein, includes a controller that has at least a part of the controlling preformed using an analog circuit. Digital controller, as used herein, includes a controller that has at least a part of the controlling preformed using an digital circuit. Microprocessor controller, as used herein, includes a controller that has at least a part of the controlling preformed using a microprocessor. Circuit, as used herein, includes analog and/or digital components, and/or a microprocessor and/or software or a portion thereof.

In other embodiments, the power supply is not a MIG power supply, but provides a welding type output or welding-type power for another process. Welding-type output, as used herein, refers to an output suitable for welding, plasma cutting or induction heating. Welding-type power as used herein, refers to welding, plasma or heating power.

Other embodiments of the present invention provide for temporal control of the welding process and/or a welding-type system. Such control is particularly well suited for short circuit MIG welding, spray transfer, and pulse spray transfer. Preferably, the control provides for controlling the output voltage utilizing a time signal derived from the voltage feedback, such as the state of the weld. State of the weld refers to whether the weld is in an arc or short state.

The time signal may avoid some of the difficulties of prior art voltage control signals because the feedback signal is a digital signal (either arc state or short state) rather than analog of varying magnitude. In other words, the only information required from the voltage feedback signal is the state of the welding arc.

It is relatively easy to distinguish between arc and short states electrically, and thus the invention provides improved electrical noise immunity. Furthermore, the invention can reduce sensitivity to changes in the impedance of the welding system.

A short circuit transfer control, in accordance with the preferred embodiment, uses the temporal signal (i.e., the state of the weld) by equating high to arc condition. Reverse logic could be used as well. The preferred logic system (high equals arc) is consistent with the actual response of the voltage waveform from a short circuit transfer. The conversion to a digital logic signal can be accomplished via a microcontroller, analog circuitry other known ways, or combination thereof.

After the digital signal indicating the weld state is provided it is used to calculate the value of eta (defined above). Eta parameters, such as functions thereof including integrals, derivatives, etc. could be derived and used as a control parameter as well. Eta parameter, as used herein, includes a parameter indicative of or derived from eta.

The preferred embodiment provides for controlling the welding output to maintain eta within a relatively narrow window about 0.25, such as between 0.2 and 0.3, to provide a stable short circuit transfer. This value and window should provide stability for a wide range of wire feed speeds and wire sizes. Other embodiments provide for a different eta setpoint and a different eta window. Eta setpoint, as used herein, includes a setpoint indicative of an acceptable or desired eta or eta parameter value. Eta window, as used herein, includes a desired or acceptable range about an eta setpoint.

The setpoint of the voltage control loop is adjusted to maintain eta within the window. In this way, the welding machine will adjust itself to obtain a close to optimal voltage setting in response to the wire feed speed set by the operator. The control thus becomes synergic and eliminates the need for the operator to set two different controls to achieve the desired welding arc.

FIG. 2 shows a welding power supply or system for welding 200 implementing this embodiment. System 200 includes a welding power source 201, a wire feeder 203, a feedback circuit 205 and a controller 207 that cooperate to provide welding power to an arc 209. Arc 209 is a short circuit MIG arc, in this embodiment, although this embodiment may be used to implement other welding processes.

Generally, power source 201 provides welding power to the arc, wire feeder 203 feeds wire to the arc, feedback circuit 205 provides arc feedback, and controller 207 controls the process. Power source 201 has at least one control input in electrical communication with a control output on controller 207 and a welding power output connected to a wire feeder 203. Wire feeder 203 also includes a wire feed speed input in electrical communication with a speed control output on controller 207. Feedback circuit 205 is responsive to the arc, and provides a feedback output, such as output voltage and/or output current to feedback inputs on controller 207. Connected to, as used herein, is a functional connection and can be direct, indirect, solitary or multiple.

Controller 207 is digital in the preferred embodiment, and includes a current control circuit 211 that receives a user setpoint 217 such as wire feed speed or current. Controller 207 also includes, in some embodiments, a voltage control circuit 213 that receives a user setpoint 221 such as a voltage or arc length setting. Controller 207 also includes a temporal or eta control circuit 214 that receives a temporal user setpoint 219 and provide a temporal or eta output. This embodiment provides that temporal control circuit 214 is an eta control circuit, and includes an eta calculation circuit to provide an eta output. Eta calculation circuit, as used herein, includes a control circuit that calculates eta or an eta parameter. Eta output, as used herein, includes an output responsive to eta or an eta parameter. The control circuits provide signals to a weld control circuit 215. The control circuits are preferably implemented in software, although various embodiments use discrete digital and/or analog circuitry to implement them.

Each user input corresponds to a knob, digital selector, or software input, etc. on the front panel. Alternatives provide for the user inputs to be made remotely, such as using a network or wirelessly, or the setpoints to be machine set and not user adjustable.

The preferred embodiment uses only two user setpoints—current user input setpoint 217 and temporal user setpoint 219, which is preferably an eta setpoint. Thus, the second knob on a traditional system that is typically for voltage control is instead for eta (or other) temporal) control. However, it can be used for a fine tuning adjustment of the arc to provide some user variability in the process. The preferred embodiment uses temporal setpoint 219 to adjust the value of the eta setpoint, and to move the eta window about the eta setpoint to allow the user to make the arc hotter or cooler. Alternatives provide for moving the eta setpoint without moving the eta window.

The eta control may be active always, or only when eta is outside the window. When active always eta control circuit 214 uses eta setpoint 219 and temporal feedback from feedback circuit 205 to control the output voltage and/or current to cause eta to become closer to the target. The control loop may include known control schemes such as PI, PID, etc., and eta control circuit 214 may include an eta averaging circuit. Eta control circuit, as used herein, includes a control circuit that provides an output responsive to eta or an eta parameter. Eta averaging circuit, as used herein, includes a control circuit that averages eta or an eta parameter

Weld control circuit 215, in response to eta or temporal control circuit 214, adjusts the output of system 200 to control eta. For example, by increasing arc voltage, the arc becomes longer, and the relative arc time becomes greater, thus eta is decreased. Conversely, decreasing the arc voltage increases eta.

When implementing the embodiment that provides for using eta control only when eta is outside the window switched off once the value meets the desired criteria. When eta control is off, weld control 215 is not responsive to the eta setpoint, and only current control is used. Embodiments that include voltage setpoint 221 may also use voltage control when eta is within the window.

Another embodiment provides for control of a spray transfer process. System 200 may be used to provide multiple processes, or dedicated systems may be used. When system 200 is used to provide a spray transfer arc, the voltage feedback is used to derive the temporal feedback, as described above.

The preferred embodiment implements the invention to control a spray transfer process by controlling the time the weld state is in an arc state. Specifically, the process is controlled so that the time in the arc state is above a desired value, or at a desired value.

The voltage setpoint of the voltage control loop (set by user input 221, or machine set), is adjusted up or down in order meet the desired arc state time. For example, temporal control circuit 214 can use an allowed number of short-arc transitions over a given time period, such as ten short-arc transition over a 100 msec time span, to control the process. The preferred embodiment provides for using a running average or some other average for the number of short-arc transitions over a given time frame. Thus, controller 207 includes an averaging circuit (such as in weld control 215 or temporal control circuit 214. The average time that may be calculated after every transition, after a set period of time, or a combination of time and transitions. The preferred embodiment uses a combination so that the time between calculations does not become too lengthy. The spray transfer embodiment does not require temporal setpoint 219 to be user set. Averaging circuit, as used herein is a circuit that average a parameter or a value responsive to a parameter, over time or over a number of weld cycles.

Alternatives provide determining the total arc time (or average total time) over a given time span. Preferably, the time selected is independent of the period of the process. This will result in a process that does not have substantially periodic short circuits. Rather, the short circuit events become pseudo random in nature. Another alternative provides for monitoring the short circuit time, the time of both arc states and short circuit states, or monitoring at least one or both of short circuit states and arc states, in a given time period.

Another embodiment provides for control of a pulse spray transfer process. System 200 may be used to provide multiple processes, or a dedicated system may be used. When system 200 is used to provide a pulse spray transfer process, the voltage feedback is used to derive the temporal feedback, as described above. That feedback is converted to eta by temporal control circuit 214. Alternatives provide that the output of circuit 214 is indicative of the number of shorts or arcs in a given time period. Temporal control circuit 214 is a short time control circuit in this embodiment. Short time control circuit, as used herein, includes a control circuit that provides an output responsive to the time the weld is in the short state.

The preferred embodiment for providing a pulse spray transfer uses characteristics of the pulse spray process to help provide a desirable temporal control. When short circuit events occur during a pulse spray transfer they usually occur during or soon after the peak pulse phase of the process. Such short circuits normally clear (i.e, the weld returns to the arc state) more quickly than the clearing of short circuits in a short circuit process. This is because they are ‘ball and tail’ short circuits. Ball and tail short circuits occur as the ball of molten material is being transferred across the arc. The molten material gets stretched with the majority constituting the ball in the lead and the stretched material connected to the un-melted wire comprising the tail. If the arc length is long enough, the tail will break before the ball reaches the puddle. In the case of a ball and tail short, the ball touches the puddle before the tail breaks.

Given the ‘ball and tail’ nature of most short circuits, it is preferable to control the process such that the average time in a short circuit is a desired value. The control is effected by changing the pulse process parameters adjusted to maintain that average short circuit time at the desired value. In this way, the average arc length can be controlled. For example, by increasing arc voltage, the arc becomes longer, and the relative arc time increases, which causes the average short circuit time to decrease. Conversely, decreasing the arc voltage increases the average short circuit time. Similarly, increasing current increases the amount of wire deposited, and increases the arc length

One embodiment is used to automatically set the appropriate pulse parameters so as to maintain the desired short duration as the operator adjusts wire feed speed. This may be done without the wire feeder communicating the actual value of the wire feed speed to the welding power source. This would allow an operator to adjust the deposition at a remote ‘dumb’ wire feeder without a control cable running back to the power source. Other embodiments include applying this control to short circuit and/or spray processes

Numerous modifications may be made to the present invention which still fall within the intended scope hereof. Thus, it should be apparent that there has been provided in accordance with the present invention a method and apparatus for welding that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

The embodiments of the invention in which an exclusive property or privilege is claimed are defined as follows:

1. A system for welding, comprising:
a welding-type power source, wherein the welding-type power source has at least one control input, and a welding-type output;
a feedback circuit, responsive to the state of the weld, and having a feedback output; and
a controller having a feedback input connected to the feedback output, having a temporal control circuit responsive to the feedback input and a control output connected to the control input.

2. The system of claim 1, wherein the temporal control circuit is an eta control circuit.

3. The system of claim 2, wherein the eta control circuit includes an eta window about an eta setpoint, and an eta calculation circuit, and wherein the eta control circuit is further responsive to the eta setpoint when the eta calculation circuit determines eta is outside the eta window.

4. The system of claim 2, wherein the eta control circuit is not responsive to the eta setpoint when the eta calculation circuit determines eta is inside the eta window.

5. The system of claim 3, wherein the eta setpoint is a user selectable eta setpoint.

6. The system of claim 1, wherein the controller has a user selectable wire feed speed setpoint and the controller has a wire feed speed control circuit connected to receive the wire feed speed setpoint, and further responsively connected to the control output.

7. The system of claim 1, wherein the controller has a voltage control circuit that receives a user selectable voltage setpoint, and that is responsively connected to the control output.

8. The system of claim 2, wherein the eta control circuit includes an output indicative of the number of short circuit states in a given time period.

9. The system of claim 2, wherein the eta control circuit includes an output indicative of the number of arc states in a given time period.

10. The system of claim 2, wherein the eta control circuit includes an eta averaging circuit responsively connected to the control output.

11. The system of claim 2, wherein the temporal control circuit includes a short time control circuit responsively connected to the control output.

12. The system of claim 11, wherein the a short time control circuit includes an averaging circuit responsively connected to the control output.

13. A method of providing welding-type power, comprising:
providing welding-type power to a weld;
monitoring the state of the weld;
temporally controlling the welding-type power in response to the monitoring.

14. The method of claim 13, wherein temporally controlling includes controlling the welding-type power in response to eta.

15. The method of claim 14, wherein controlling the welding-type power in response to eta includes establishing an eta parameter window about an eta parameter setpoint.

16. The method of claim 15, further comprising, not controlling the welding-type power in response to eta when an eta parameter is outside the eta parameter window and controlling the welding-type power when the eta parameter is inside the eta parameter window.

17. The method of claim 15, further comprising obtaining the eta parameter setpoint from a user selectable input.

18. The method of claim 13, further comprising receiving a user selectable wire feed speed setpoint and controlling the welding-type power in response to the wire feed speed setpoint, and further in response to the welding output.

19. The method of claim 16, further comprising receiving a user selectable wire feed speed setpoint and controlling the welding-type power in response to the a wire feed speed setpoint and further in response to the welding output, when the eta parameter is outside the eta parameter window.

20. The method of claim 13, further comprising controlling the welding-type power in response to a user selectable voltage setpoint, and further in response to the welding -type output.

21. The method of claim 20, wherein temporally controlling the welding-type power comprises determining the number of at least one of short circuit states and arc states in a given time period.

22. The method of claim 14, further comprising controlling the welding-type power in response to a user selectable voltage setpoint, and further in response to the welding -type output, and wherein controlling the welding-type power in response to eta includes averaging eta over a period of time.

23. The method of claim 13, wherein temporally controlling the welding-type power includes controlling the length of time the welding-type output is in the short state.

24. The method of claim 23, wherein controlling the length of time the welding-type output is in the short state includes determining and averaging the time the welding-type output is in the short state.

25. A system of welding, comprising:
means for providing welding-type power to a weld;
means for monitoring the state of the weld;
means for temporally controlling the welding-type power in response to the means for monitoring.

26. The system of claim 25, wherein the means for temporally controlling includes means for determining an eta parameter in response to the means for monitoring and further includes means for controlling the welding-type power in response to eta.

27. The system of claim 26, wherein the means for controlling the welding-type power in response to eta includes means for establishing an eta parameter window about an eta parameter setpoint.

28. The system of claim 27, further comprising, means for not controlling the welding-type power in response to eta when an eta parameter is outside the eta parameter window and for controlling the welding-type power the eta parameter when the eta parameter is inside the eta parameter window.

29. The system of claim 28, further comprising means for obtaining the eta parameter setpoint from a user selectable input.

30. The system of claim 26, further comprising means for receiving a user selectable wire feed speed setpoint and for controlling the welding-type power in response to the wire feed speed setpoint, and in responsive to the welding output.

31. The system of claim 29, further comprising means for receiving a user selectable wire feed speed setpoint and for controlling the welding-type power in response to the a wire feed speed setpoint and the welding output when the eta parameter is outside the eta parameter window.

32. The system of claim 25, further comprising means for controlling the welding-type power in response to a user selectable voltage setpoint and in response to the welding -type output.

33. The system of claim 32, wherein the means for temporally controlling the welding-type power comprises means for determining the number of at least one of short circuit states and arc states in a given time period.

34. The system of claim 26, further comprising means for controlling the welding-type power in response to a user selectable voltage setpoint and in response to the welding -type output, and wherein the means for controlling the welding-type power in response to eta includes means for averaging eta over a period of time.

35. The system of claim 25, wherein the means for temporally controlling the welding-type power includes means for controlling the length of time the welding-type output is in the short state.

36. The system of claim 35, wherein the means for controlling the length of time the welding-type output is in the short state includes means for determining and averaging the time the welding-type output is in the short state.

37. A system for welding, comprising:
a welding-type power source, wherein the welding-type power source has at least one control input, and a welding-type output;
a feedback circuit, responsive to state of the weld, and having a feedback output; and
a controller having a feedback input connected to the feedback output, having a temporal control circuit responsive to the feedback input and a control output responsive to the length of at least one arc state, and connected to the control input.

38. The system of claim 37, wherein the control output is responsive to the number of arc states in a given time period.

39. The system of claim 38, wherein the controller further includes a voltage control circuit that is responsively connected to the control output.

40. The system of claim 39, wherein the voltage control circuit receives a user selectable input.

41. The system of claim 37, wherein the temporal control circuit includes an averaging circuit responsively connected to the control output.

42. A method of providing welding type power, comprising:
providing welding-type power to a weld;
monitoring the state of the weld;
temporally controlling the welding-type power in response to the monitoring and the duration of at least one arc state.

43. The method of claim 42, wherein temporally controlling includes determining the number of arc states in a given time period.

44. The method of claim 43, wherein temporally controlling further includes adjusting an output voltage in response to the number of arc states in a given time period.

45. The method claim 44, further comprising receiving a voltage setpoint from a user selectable input.

46. The method of claim 42, wherein temporally controlling includes averaging the duration of a plurality of arc states.

47. A system for of welding, comprising:
means for providing welding-type power to a weld;
means for monitoring the state of the weld;
means for temporally controlling the means for providing welding-type power in response to the means for monitoring and in response to the duration of at least one arc state, wherein the means for temporally controlling is connected to the means for providing welding-type power and connected to the means for monitoring.

48. The system of claim 47, wherein the means for temporally controlling includes means for determining the number of arc states in a given time period.

49. The system of claim 48, wherein the means for temporally controlling further includes means for adjusting an output voltage in response to the number of arc states in a given time period.

50. The system claim 49, further comprising means for receiving a voltage setpoint from a user selectable input, connected to the means for temporally controlling.

51. The system of claim 47, wherein the means for temporally controlling includes means for averaging the duration of a plurality of arc states.
